(19) United States
(12) Patent Application Publication
(10) Pub. No.: US 2009/0058354 A1
(43) Pub. Date: Mar. 5, 2009

(54) SOLAR-POWERED MEDIA SYSTEM AND APPARATUS

(76) Inventor: SOREN DAVID HARRISON, Somerville, MA (US)

Correspondence Address: BROWN RUDNICK LLP, ONE FINANCIAL CENTER, BOSTON, MA, 02111, US

(21) Appl. No.: 12/204,353

(22) Filed: Sep. 4, 2008

Related U.S. Application Data
(60) Provisional application No. 60/969,775, filed on Sep. 4, 2007.

(51) Int. Cl. H02J 7/00

(52) U.S. Cl. 320/101

(57) ABSTRACT

Solar-powered media systems and apparatuses are disclosed. The solar-powered media systems and apparatuses comprise shade structures, solar cells, energy storage devices, electronics and/or circuitry, docking stations, wireless communications devices, and audio and/or visual components capable of outputting media content. One aspect of the solar-powered media system and apparatus pertains to shade structures, which provide shade for one or more users. Another aspect of the disclosure pertains to energy storage devices, which store electrical energy to power the solar-powered media system. Another aspect of the disclosure pertains to docking stations, which allow communication and electrical energy transfer between various devices. Another aspect of the disclosure pertains to audio & visual components capable of outputting media content for one or more users. Another aspect of the disclosure pertains to solar cells integrated into or attached to the said shade structure. All aspects can be utilized alone or in combination with one another.

### BACKGROUND OF THE INVENTION

1. Field of the Invention

The present invention relates to shade structures & outdoor furniture, media devices, and more specifically, solar-powered media devices integrated into shade structures.

2. Description of the Related Art

There are many shade structures currently available to consumers including beach umbrellas, patio & market umbrellas, and canopies, to name a few. Similarly, a wide variety of portable electronics, which require electrical power enjoy extreme popularity; portable media players, handheld devices, cellular phones, and others are used regularly by much of the U.S. population. A variety of solar-powered chargers for many different devices exist. Many solar chargers provide a portable solution to charging handheld devices, media players, and cellular phones, but typically these small solar chargers are carried in a user's pocket, backpack, or purse. There are also a wide variety of docking stations for outputting media and information from portable media players, which require a source of electrical energy and typically utilize batteries and/or wall mounted electrical outlets. Prolonged outdoor and/or remote use of portable media devices, handhelds devices, and cellular phones, among others, is severely limited by access to a source of electricity. Prolonged outdoor or remote activities often require shade structures for protection from solar insolation, in which case current solar-powered chargers are only marginally effective. Such chargers also lack the capability to output media information. What is needed then is an integrated solar-powered media system; one possible embodiment of such a media system integrates a shade structure, charging electronics, and audio components for outputting media information. The present invention fulfills this need.

### BRIEF SUMMARY OF THE INVENTION

Broadly speaking, the present invention relates to solar-powered media systems and apparatuses. The invention can be implemented in numerous ways. Solar cells and energy storage devices, docking stations, electronics and/or circuitry, audio components and/or video components capable of outputting media content for one or more users, or a wireless media player and transmission system capable of transmitting information and/or power over a wireless connection to any other device can be, alone or in any combination, integrated into or attached to one or more permanent or temporary shade structures, including but not limited to beach umbrellas, patio & market umbrellas, awnings, and/or canopies.

By way of example, one embodiment of the present invention comprises a beach umbrella with solar cells integrated into the fabric of the shade material; audio speakers attached to the supporting structure of the umbrella; an iPod® docking station mounted on the umbrella pole; rechargeable batteries, an audio amplifier, and the associated circuitry imbedded within the umbrella structure and/or docking station.

These and various other aspects and advantages that characterize the present invention will become apparent from the following detailed description taken in conjunction with the accompanying drawings which, by way of example, illustrate the principles of the invention.

### BRIEF DESCRIPTION OF THE DRAWING

FIG. 1—One example of a solar powered media system with beach umbrella-integrated solar cells, speakers, iPod dock, and the associated circuitry.

FIG. 2—In addition to the primary device (i.e. iPod) charging and docking station, the docking station allows other devices to be connected to the solar powered media system. Information and power can be transmitted to or from other devices.

FIG. 3—Solar cells are integrated into or mounted on the umbrella fabric. Speakers can be integrated into or mounted in a variety of locations. Each can be designed such that the functionality (folding & unfolding) of the umbrella is retained.

FIG. 4—Another possible solar powered media system would utilize a patio or market umbrella in much the same way as the beach umbrella.

FIG. 5—Another possible solar powered media system would integrate the docking station and connection interface into, for example, the table of a patio set.

### DETAILED DESCRIPTION OF THE INVENTION

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

The present invention, a solar powered media system, is comprised of: a shade structure; solar cells; energy storage devices; a docking station; electronics and/or circuitry; audio components and/or video components capable of outputting media content for one or more users; and a wireless media player and transmission system capable of transmitting information and/or power over a wireless connection to any other device.

The solar cells can be configured to provide electrical power to: one or more shade structures; one or more energy storage devices, docking stations, electronics and/or circuitry; audio components capable of outputting media content for one or more users and/or video components capable of outputting media content for one or more users; one or more wireless media players; one or more wireless transmission systems capable of transmitting information and/or power over a wireless connection to one or more other devices; one or more handheld and/or one or more portable media devices and/or one or more telecommunications devices. The energy storage devices are configured to provide electrical energy to one or more of the subcomponents (speakers, circuitry, etc . . . ) in any combination. The docking stations include connection interfaces capable of, but not limited to, transferring information and power to other devices and/or systems.

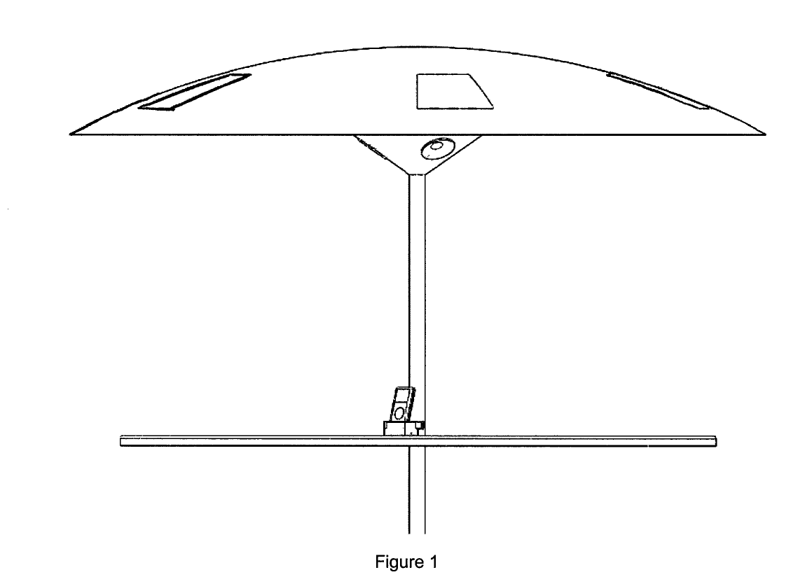

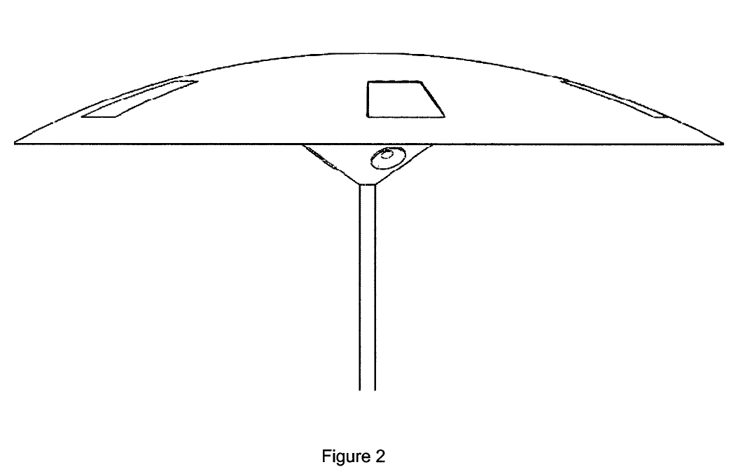

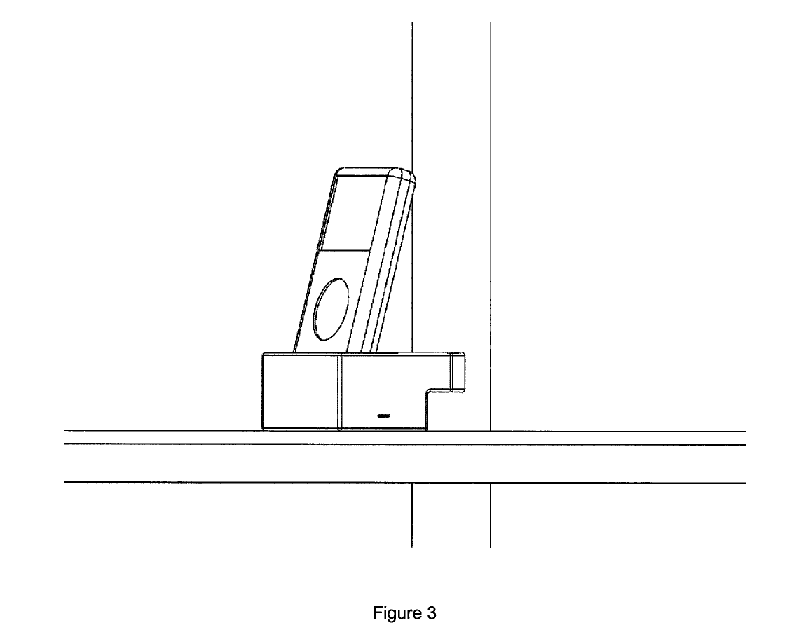

An explicit example of such a solar-powered media system is a solar powered sound dock. This particular sound dock utilizes a beach umbrella for mounting solar cells, audio speakers, and a docking station (FIG. 1). Solar cells integrated into the top of the umbrella fabric provide electrical power to charge an iPod and output audio content from the iPod, as well (FIG. 2). To avoid loss of electrical power during cloudy periods or as the sun begins to set, rechargeable batteries and the associated charging circuitry are powered by the solar cells as well. The docking station (FIG. 3) holds the iPod firmly in place while charging its internal battery and transmitting the audio output. The docking station houses the rechargeable battery, charging circuitry, and audio amplification circuitry, and additionally, allows other devices to be connected via a USB interface, ⅛″ audio jack, and other generic plugs. Flexible solar cells and specially designed speaker housings allow the beach umbrella to fold and unfold as normal.

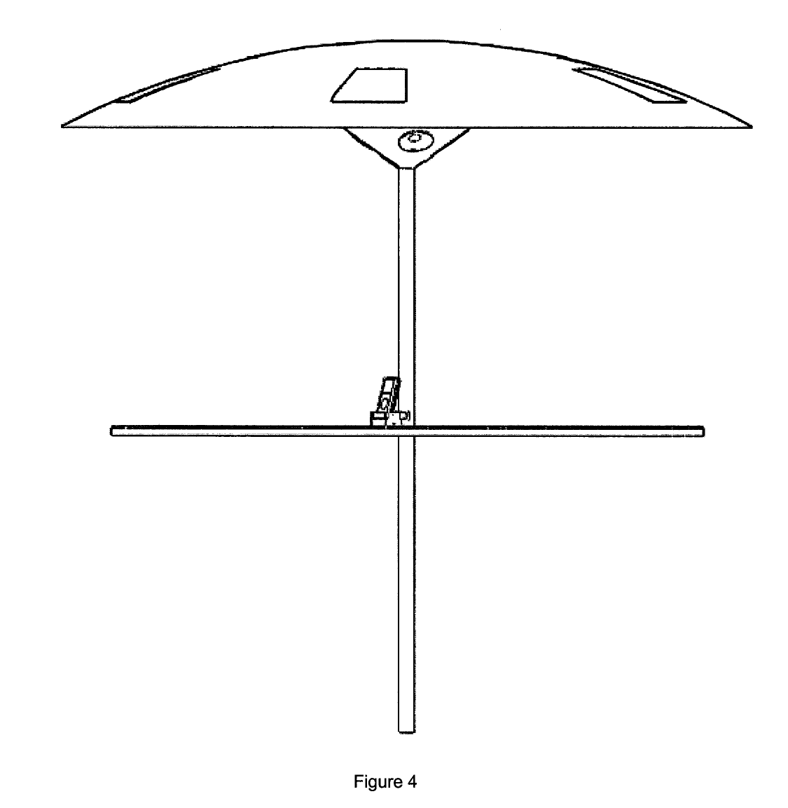

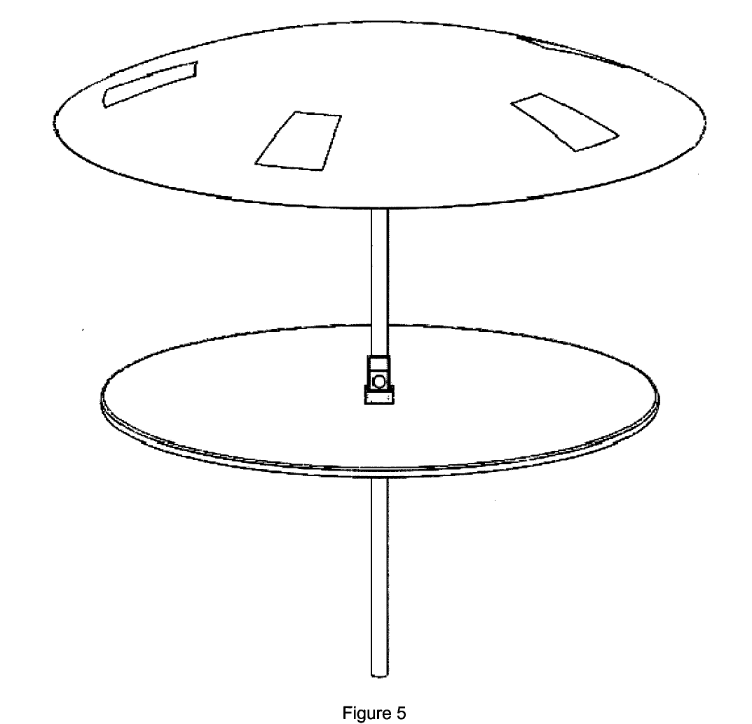

A solar-powered media system could similarly be implemented in patio/market umbrellas (FIG. 4). The docking station, circuitry, and/or additional speakers could also be integrated into the patio table or other similar structures (FIG. 5). Other implementations of solar-powered media systems and apparatuses include those that combine such systems with outdoor furniture and other items such as, but not limited to, chairs, coolers, hammocks, canopies, and carts. Such items may also include aspects of the disclosed invention together or alone, in any combination.

What is claimed is:

1. A media system comprising: a shade structure; solar cells; energy storage devices; a docking station; electronics and/or circuitry; audio components and/or video components capable of outputting media content for one or more users; and a wireless media player and transmission system capable of transmitting information and/or power over a wireless connection to any other device.

2. The system and apparatus of claim 1, wherein the solar cells are configured to provide electrical power to one or more shade structures.

3. The system of claim 1, wherein the solar cells are configured to provide electrical energy to one or more energy storage devices.

4. The system of claim 1, wherein the solar cells are configured to provide electrical energy to a docking station

5. The system of claim 1, wherein the solar cells are configured to provide electrical energy to electronics and/or circuitry.

6. The system of claim 1, wherein the solar cells are configured to provide electrical energy to one or more docking stations.

7. The system of claim 1, wherein the solar cells are configured to provide electrical energy to audio components capable of outputting media content for one or more users.

8. The system of claim 1, wherein the solar cells are configured to provide electrical energy to video components capable of outputting media content for one or more users.

9. The system of claim 1, wherein the solar cells are configured to provide electrical energy to one or more wireless media players.

10. The system of claim 1, wherein the solar cells are configured to provide electrical energy to one or more wireless transmission systems capable of transmitting information and/or power over a wireless connection to one or more other devices.

11. The system of claim 1, wherein the solar cells are configured to provide electrical energy to one or more handheld and/or one or more portable media devices and/or one or more telecommunications devices.

12. The energy storage devices of claim 3, wherein the energy storage devices are configured to provide electrical energy.

13. The docking station of claim 4, further comprising one or more connection interfaces capable of but not limited to transferring information and power.

14. The system of claim 1, wherein the docking station attaches to or is integrated into the shade structure.

15. The system of claim 1, wherein the system attaches to or are integrated into the shade structure.
